(19) United States
(12) Patent Application Publication
(10) Pub. No.: US 2026/0088572 A1
(43) Pub. Date: Mar. 26, 2026

(54) Connector Signal Transmission System, Connector Signal Transmission Method Thereof, Connector assembly, and Board-End Connector

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW); HAO-HSUAN Lin, Taipei City (TW)

(21) Appl. No.: 19/296,889

(22) Filed: Aug. 11, 2025

(30) Foreign Application Priority Data
Sep. 25, 2024 (TW) 113136491

(51) Int. Cl. H01R 13/641; H01R 12/79

(52) U.S. Cl. CPC H01R 13/641; H01R 12/79

(57) ABSTRACT

A connector signal transmission system, a connector signal transmission method thereof, a connector assembly, and a board-end connector are provided. The connector assembly further comprises a cable-end connector engaged with the board-end connector, and the connector signal transmission system comprises a circuit board. The circuit board is configured to enable signal transmission to the connector assembly after the conductive terminals of the board-end connector and the cable-end connector have come into contact and have been effectively engaged. In this manner, the technical problem in conventional connector assemblies, wherein the plurality of connectors thereof tend to fail to effectively transmit signals due to incomplete engagement, can be resolved. Consequently, the connector assembly of the present application can transmit signals in a timely manner and perform as expected within an electronic device.

### CROSS-REFERENCE TO RELATED APPLICATIONS

This application claims the priority of Republic of China Patent Application No. 113136491 filed on Sep. 25, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to a connector signal transmission system capable of transmitting signals in a timely manner, a connector signal transmission method thereof, a connector assembly, and a board-end connector.

### Descriptions of the Related Art

Electronic devices often require a connector assembly, and generally the connector assembly comprises a plurality of connectors that are engaged to transmit signals. However, the plurality of connectors within the connector assembly may not achieve successful signal transmission due to ineffective engagement, thereby causing the connector assembly to fail to function as expected for the electronic device.

In view of the above, how to prevent the plurality of connectors within the connector assembly from transmitting signals before the connectors are effectively engaged during the process of engaging the connectors, has become an urgent issue for those skilled in the related technical field.

### SUMMARY OF THE INVENTION

In view of the drawbacks of the prior art mentioned above, the present application provides a board-end connector configured to be paired with a signal transmission module, wherein the signal transmission module is configured to provide a first terminal signal and a second terminal signal, and the board-end connector is further configured to be paired with a cable-end connector to form a connector assembly, the connector assembly comprising a first connector engaging side and a second connector engaging side, wherein the cable-end connector is engaged with the board-end connector at the first connector engaging side and the second connector engaging side, and comprises a cable-end signal terminal set and a cable-end effective engagement detection conductor, wherein the cable-end effective engagement detection conductor is extended from the first connector engaging side to the second connector engaging side, and the cable-end signal terminal set comprises a first cable-end signal terminal disposed at the first connector engaging side and a second cable-end signal terminal disposed at the second connector engaging side; the board-end connector comprising: a board-end signal terminal set electrically connected to the signal transmission module and comprising a first board-end signal terminal and a second board-end signal terminal, wherein the first board-end signal terminal comprises a first board-end signal terminal engaging structure, and the second board-end signal terminal comprises a second board-end signal terminal engaging structure; a board-end effective engagement detection component set comprising a first board-end effective engagement detection component and a second board-end effective engagement detection component, wherein the first board-end effective engagement detection component comprises a first board-end effective engagement detection component engaging structure, and the second board-end effective engagement detection component comprises a second board-end effective engagement detection component engaging structure; and a board-end insulating core configured to be mated with and to position the board-end signal terminal set and the board-end effective engagement detection component set, such that the first board-end signal terminal engaging structure is disposed at the first connector engaging side, the second board-end signal terminal engaging structure is disposed at the second connector engaging side, the first board-end effective engagement detection component engaging structure is disposed at the first connector engaging side, and the second board-end effective engagement detection component engaging structure is disposed at the second connector engaging side; wherein, during engagement between the cable-end connector and the board-end connector, when the first board-end signal terminal engaging structure and the second board-end signal terminal engaging structure are electrically in contact with the first cable-end signal terminal and the second cable-end signal terminal respectively, and when the first board-end effective engagement detection component and the second board-end effective engagement detection component electrically abut the cable-end effective engagement detection conductor, the cable-end connector is effectively engaged with the board-end connector at the first connector engaging side and the second connector engaging side, such that the signal transmission module is enabled to transmit the first terminal signal to the first cable-end signal terminal via the first board-end signal terminal and to transmit the second terminal signal to the second cable-end signal terminal via the second board-end signal terminal.

Preferably, the board-end connector said above, wherein the board-end signal terminal set is disposed between the first board-end effective engagement detection component and the second board-end effective engagement detection component.

Preferably, the board-end connector said above, wherein the first board-end effective engagement detection component comprises a first board-end effective engagement detection component elastic abutting arm, and the second board-end effective engagement detection component comprises a second board-end effective engagement detection component elastic abutting arm, wherein the first board-end effective engagement detection component elastic abutting arm and the second board-end effective engagement detection component elastic abutting arm are configured to elastically abut the cable-end effective engagement detection conductor.

Additionally, the present application further provides a connector assembly comprising a first connector engaging side and a second connector engaging side, and configured to be paired with a signal transmission module, wherein the signal transmission module is configured to provide a first terminal signal and a second terminal signal; the connector assembly comprising: a board-end connector, comprising: a board-end signal terminal set electrically connected to the signal transmission module and comprising a first board-end signal terminal and a second board-end signal terminal, wherein the first board-end signal terminal comprises a first board-end signal terminal engaging structure, and the second board-end signal terminal comprises a second board-end signal terminal engaging structure; a board-end effective engagement detection component set comprising a first board-end effective engagement detection component and a second board-end effective engagement detection component, wherein the first board-end effective engagement detection component comprises a first board-end effective engagement detection component engaging structure, and the second board-end effective engagement detection component comprises a second board-end effective engagement detection component engaging structure; and a board-end insulating core configured to be mated with and to position the board-end signal terminal set and the board-end effective engagement detection component set, such that the first board-end signal terminal engaging structure is disposed at the first connector engaging side, the second board-end signal terminal engaging structure is disposed at the second connector engaging side, the first board-end effective engagement detection component engaging structure is disposed at the first connector engaging side, and the second board-end effective engagement detection component engaging structure is disposed at the second connector engaging side; and a cable-end connector engaged with the board-end connector at the first connector engaging side and the second connector engaging side, the cable-end connector comprising: a cable-end signal terminal set comprising a first cable-end signal terminal and a second cable-end signal terminal, wherein the first cable-end signal terminal comprises a first cable-end signal terminal engaging structure, and the second cable-end signal terminal comprises a second cable-end signal terminal engaging structure; a cable-end insulating core configured to be mated with and to position the cable-end signal terminal set, such that the first cable-end signal terminal engaging structure is disposed at the first connector engaging side, and the second cable-end signal terminal engaging structure is disposed at the second connector engaging side; and a cable-end effective engagement detection conductor comprising a first cable-end effective engagement detection conductor structure and a second cable-end effective engagement detection conductor structure, wherein the cable-end effective engagement detection conductor is mated with the cable-end insulating core such that the first cable-end effective engagement detection conductor structure is disposed at the first connector engaging side, and the second cable-end effective engagement detection conductor structure is disposed at the second connector engaging side; wherein, during engagement of the cable-end connector with the board-end connector, when the first board-end signal terminal engaging structure and the second board-end signal terminal engaging structure are electrically in contact with the first cable-end signal terminal engaging structure and the second cable-end signal terminal engaging structure respectively, and when the first board-end effective engagement detection component and the second board-end effective engagement detection component electrically abut the first cable-end effective engagement detection conductor structure and the second cable-end effective engagement detection conductor structure respectively, the cable-end connector is effectively engaged with the board-end connector at the first connector engaging side and the second connector engaging side, such that the signal transmission module is enabled to transmit the first terminal signal to the first cable-end signal terminal via the first board-end signal terminal and to transmit the second terminal signal to the second cable-end signal terminal via the second board-end signal terminal.

Preferably, the connector assembly said above, wherein the cable-end effective engagement detection conductor is a metal shell or conductive material to be mated with the cable-end insulating core.

Preferably, the connector assembly said above, wherein the first board-end signal terminal and the second board-end signal terminal are blade terminals, and the first cable-end signal terminal and the second cable-end signal terminal are clip-arm terminals.

Preferably, the connector assembly said above, wherein the board-end connector further comprises a board-end force-bearing member set, and the board-end force-bearing member set comprises a first board-end force-bearing member and a second board-end force-bearing member, wherein the first board-end force-bearing member and the second board-end force-bearing member respectively comprise a first board-end force-bearing member locking structure and a second board-end force-bearing member locking structure, and the board-end insulating core is further configured to be mated with and to position the board-end force-bearing member set, such that the first board-end force-bearing member locking structure and the second board-end force-bearing member locking structure are respectively disposed at the first connector engaging side and the second connector engaging side; wherein, when the cable-end connector is effectively engaged with the board-end connector at the first connector engaging side and the second connector engaging side, the first board-end force-bearing member locking structure and the second board-end force-bearing member locking structure are configured to lock and position the cable-end connector.

Preferably, the connector assembly said above, wherein when the cable-end connector is effectively engaged with the board-end connector at the first connector engaging side and the second connector engaging side, the first board-end force-bearing member locking structure and the second board-end force-bearing member locking structure are configured to lock and position the cable-end effective engagement detection conductor or the cable-end insulating core.

Additionally, the present application further provides a connector signal transmission system comprising: a circuit board comprising a control module, a signal transmission module, a terminal contact detection module, and an effective engagement detection module, wherein the signal transmission module is configured to transmit a first terminal signal and a second terminal signal; and a connector assembly comprising a first connector engaging side and a second connector engaging side, the connector assembly comprising a board-end connector and a cable-end connector, wherein the board-end connector is disposed on the circuit board, and the cable-end connector is engaged with the board-end connector at the first connector engaging side and the second connector engaging side, wherein, the board-end connector comprises: a board-end signal terminal set electrically connected to the terminal contact detection module and the signal transmission module, and comprising a first board-end signal terminal and a second board-end signal terminal, wherein the first board-end signal terminal comprises a first board-end signal terminal engaging structure disposed at the first connector engaging side, and the second board-end signal terminal comprises a second board-end signal terminal engaging structure disposed at the second connector engaging side; and a board-end effective engagement detection component set electrically connected to the effective engagement detection module, and comprising a first board-end effective engagement detection component and a second board-end effective engagement detection component, wherein the first board-end effective engagement detection component and the second board-end effective engagement detection component respectively comprise a first board-end effective engagement detection component engaging structure and a second board-end effective engagement detection component engaging structure, and the first board-end effective engagement detection component engaging structure and the second board-end effective engagement detection component engaging structure are respectively disposed at the first connector engaging side and the second connector engaging side; and the cable-end connector comprises: a cable-end signal terminal set comprising a first cable-end signal terminal and a second cable-end signal terminal, wherein the first cable-end signal terminal and the second cable-end signal terminal respectively comprise a first cable-end signal terminal engaging structure and a second cable-end signal terminal engaging structure, and the first cable-end signal terminal engaging structure and the second cable-end signal terminal engaging structure are respectively disposed at the first connector engaging side and the second connector engaging side; and a cable-end effective engagement detection conductor extended from the first connector engaging side to the second connector engaging side; wherein, during engagement of the cable-end connector with the board-end connector, the control module is configured to instruct the terminal contact detection module to detect whether the board-end signal terminal set is in electrical contact with the cable-end signal terminal set, and the control module is further configured to instruct the effective engagement detection module to detect whether the board-end effective engagement detection component set electrically abut the cable-end effective engagement detection conductor; when the terminal contact detection module detects that the first board-end signal terminal engaging structure and the second board-end signal terminal engaging structure are in electrical contact with the first cable-end signal terminal engaging structure and the second cable-end signal terminal engaging structure respectively, and when the effective engagement detection module detects that the first board-end effective engagement detection component and the second board-end effective engagement detection component electrically abut the cable-end effective engagement detection conductor, the cable-end connector is effectively engaged with the board-end connector at the first connector engaging side and the second connector engaging side, such that the control module instructs the signal transmission module to transmit the first terminal signal to the first cable-end signal terminal via the first board-end signal terminal and to transmit the second terminal signal to the second cable-end signal terminal via the second board-end signal terminal.

Additionally, the present application further provides a connector signal transmission method for use in a connector signal transmission system, wherein, the connector signal transmission system comprises a circuit board and a connector assembly, the connector assembly comprising a first connector engaging side and a second connector engaging side; the circuit board comprises a signal transmission module, a terminal contact detection module, and an effective engagement detection module, wherein the signal transmission module is configured to transmit a first terminal signal and a second terminal signal; the connector assembly comprises a board-end connector and a cable-end connector; the board-end connector comprises a board-end signal terminal set and a board-end effective engagement detection component set, and is disposed on the circuit board, such that the board-end signal terminal set is electrically connected to the terminal contact detection module and the signal transmission module, and the board-end effective engagement detection component set is electrically connected to the effective engagement detection module, wherein the board-end signal terminal set comprises a first board-end signal terminal and a second board-end signal terminal, and the board-end effective engagement detection component set comprises a first board-end effective engagement detection component and a second board-end effective engagement detection component; the cable-end connector is engaged with the board-end connector, and comprises a cable-end signal terminal set and a cable-end effective engagement detection conductor, wherein the cable-end signal terminal set comprises a first cable-end signal terminal and a second cable-end signal terminal, and the cable-end effective engagement detection conductor is extended from the first connector engaging side to the second connector engaging side; the connector signal transmission method comprises: detecting by the terminal contact detection module whether the board-end signal terminal set is in electrical contact with the cable-end signal terminal set; detecting by the effective engagement detection module whether the board-end effective engagement detection component set electrically abuts the cable-end effective engagement detection conductor; and when the terminal contact detection module detects that the first board-end signal terminal and the second board-end signal terminal are respectively in electrical contact with the first cable-end signal terminal and the second cable-end signal terminal, and when the effective engagement detection module detects that the first board-end effective engagement detection component and the second board-end effective engagement detection component electrically abut with the cable-end effective engagement detection conductor, enabling the signal transmission module to transmit the first terminal signal to the first cable-end signal terminal via the first board-end signal terminal and to transmit the second terminal signal to the second cable-end signal terminal via the second board-end signal terminal.

Preferably, the connector signal transmission method said above, wherein the time at which the board-end signal terminal set is in electrical contact with the cable-end signal terminal set is earlier than the time at which the board-end effective engagement detection component set electrically abuts the cable-end effective engagement detection conductor, such that when the cable-end connector is effectively engaged with the board-end connector at the first connector engaging side and the second connector engaging side, the first board-end signal terminal is electrically in contact with the first cable-end signal terminal, and the second board-end signal terminal is electrically in contact with the second cable-end signal terminal.

Compared to prior art, the present application provides a connector signal transmission system, a connector signal transmission method thereof, a connector assembly, and a board-end connector are provided. The connector assembly further comprises a cable-end connector engaged with the board-end connector, and the connector signal transmission system comprises a circuit board. The circuit board is configured to enable signal transmission to the connector assembly after the conductive terminals of the board-end connector and the cable-end connector have come into contact and have been effectively engaged. In this manner, the technical problem in conventional connector assemblies, wherein the plurality of connectors thereof tend to fail to effectively transmit signals due to incomplete engagement, can be resolved. Consequently, the connector assembly of the present application can transmit signals in a timely manner and perform as expected within an electronic device.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of a connector signal transmission system according to an embodiment of the present application.

FIG. 2 is a perspective schematic view of a connector assembly according to an embodiment of the present application.

FIG. 3 is a top schematic view of the connector assembly according to an embodiment of the present application.

FIG. 4 is a cross-sectional schematic view of a portion of the connector assembly shown in FIG. 3, taken along line AA.

FIG. 5 is a cross-sectional schematic view of a portion of the connector assembly shown in FIG. 3, taken along line A′A′.

FIG. 6 is a front schematic view of a portion of the connector assembly according to an embodiment of the present application.

FIG. 7 is a perspective schematic view of a portion of the connector assembly according to an embodiment of the present application.

FIG. 8 is a front schematic view of a portion of the connector assembly according to an embodiment of the present application.

FIG. 9 is a perspective schematic view of a portion of the connector assembly according to an embodiment of the present application.

FIG. 10 is a perspective schematic view of a board-end connector according to an embodiment of the present application.

FIG. 11 is a perspective schematic view of a cable-end connector according to an embodiment of the present application.

FIG. 12 is a flowchart illustrating a connector signal transmission method according to an embodiment of the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will effectively convey the scope of the invention to those skilled in the art.

It should be noted that, for the sake of clarity and conciseness, components comprising the same or similar functions in the following embodiments are denoted by the same reference numerals, and descriptions of identical or equivalent features are omitted.

The present application provides a connector signal transmission system, a connector signal transmission method thereof, a connector assembly, and a board-end connector. The connector assembly further comprises a cable-end connector engaged with the board-end connector, and the connector signal transmission system comprises a circuit board. The circuit board is configured to enable signal transmission to the connector assembly after the conductive terminals of the board-end connector and the cable-end connector have come into contact and have been effectively engaged. In this way, the technical problem encountered in conventional connector assemblies, where a plurality of connectors tend to fail to transmit signals effectively due to incomplete engagement, can be addressed. Accordingly, the connector assembly of the present application is capable of transmitting signals in a timely manner and thus performs as expected within an electronic device.

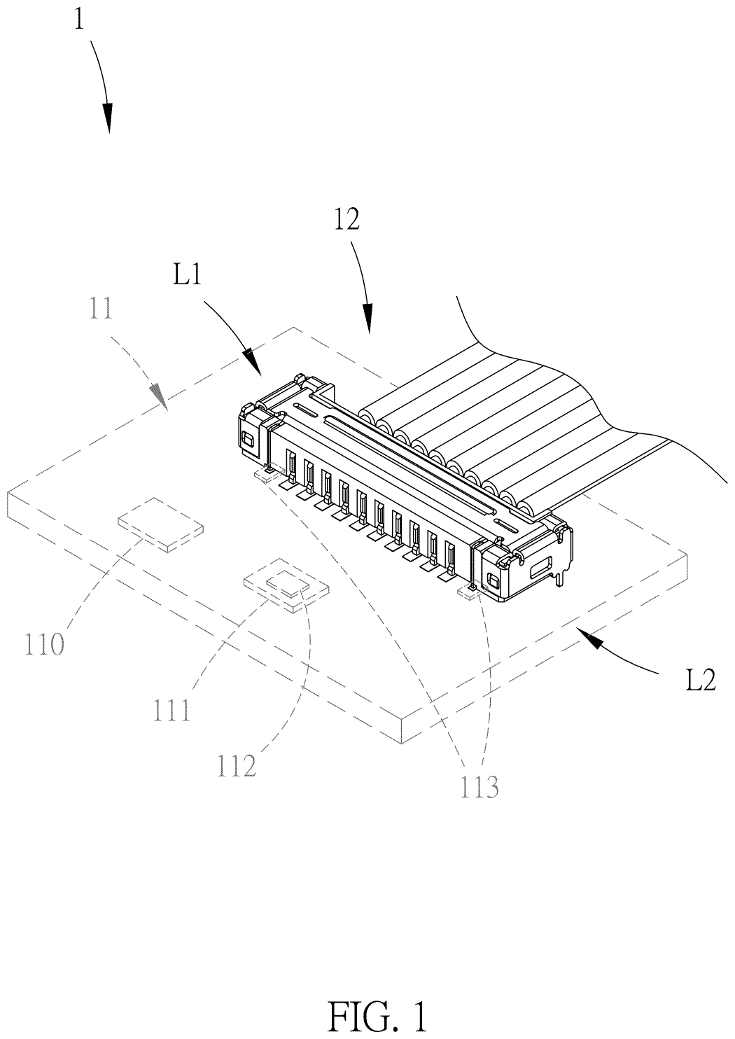

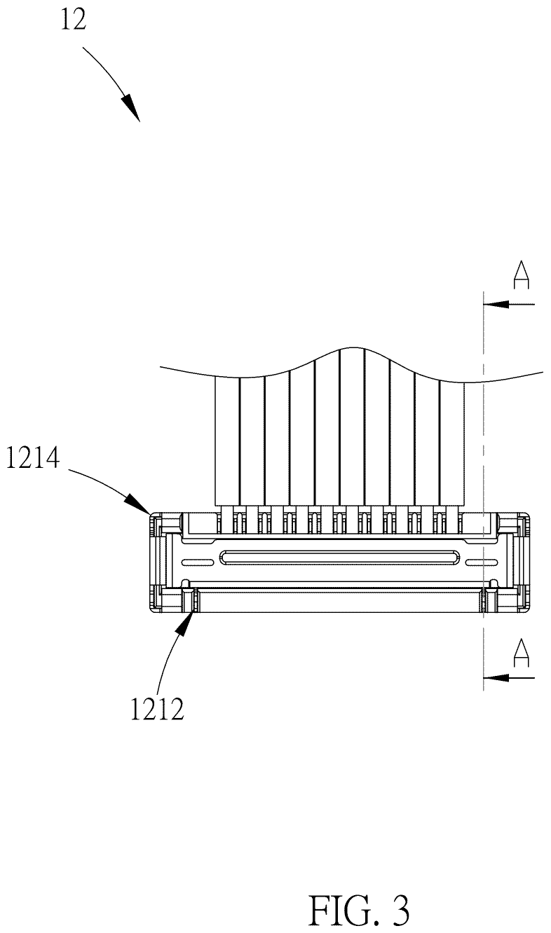

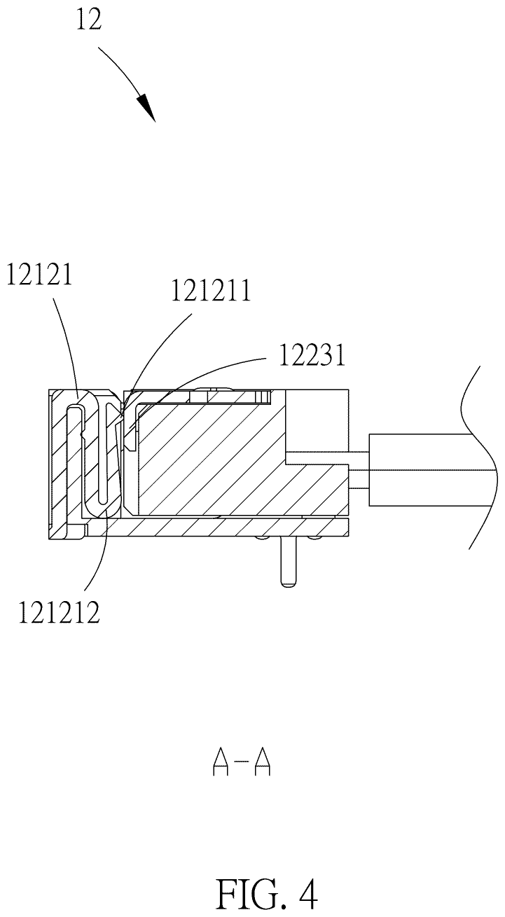

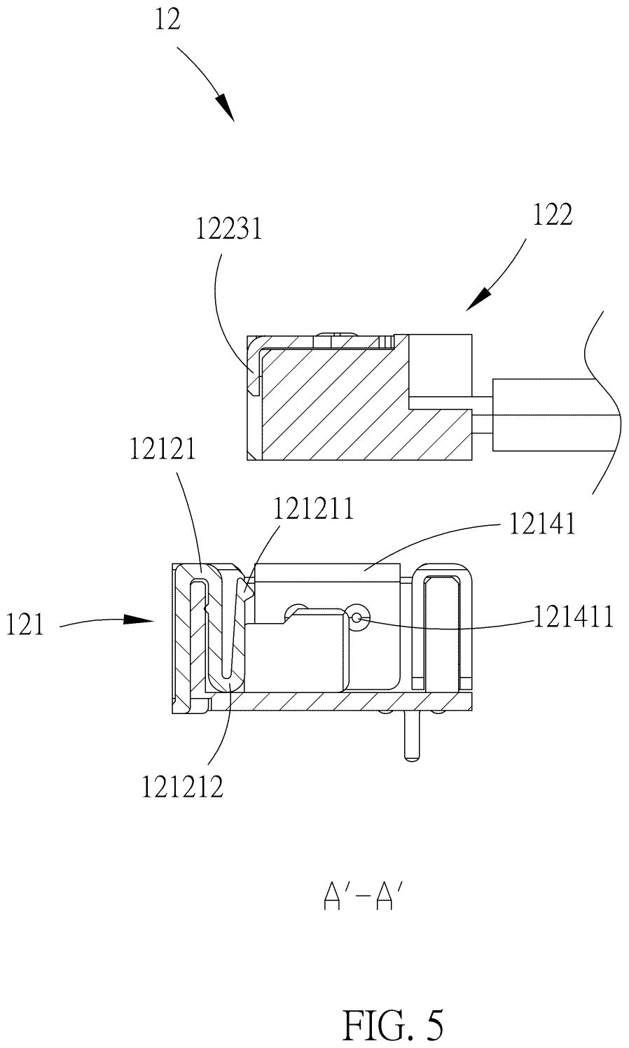

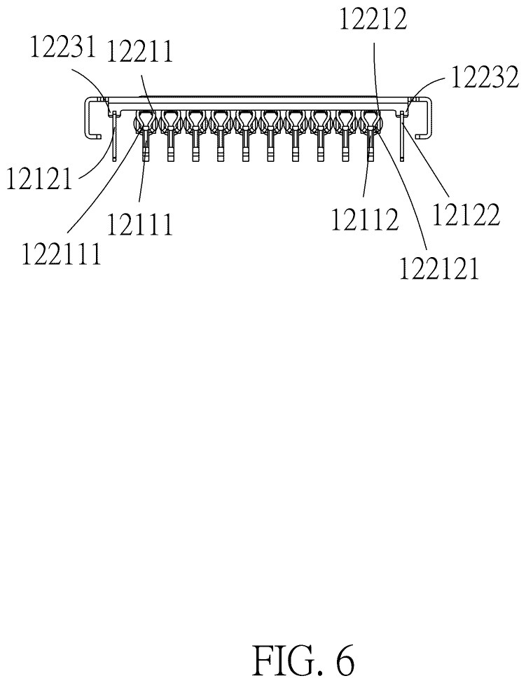

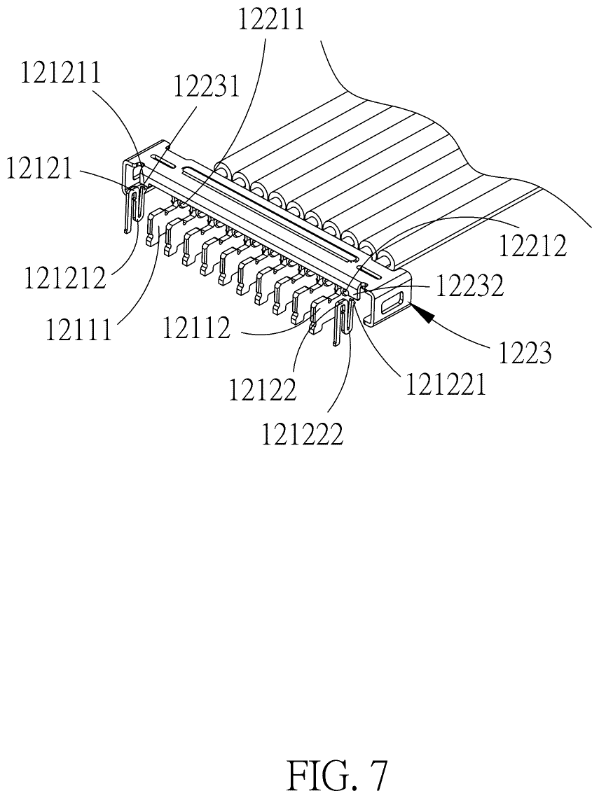

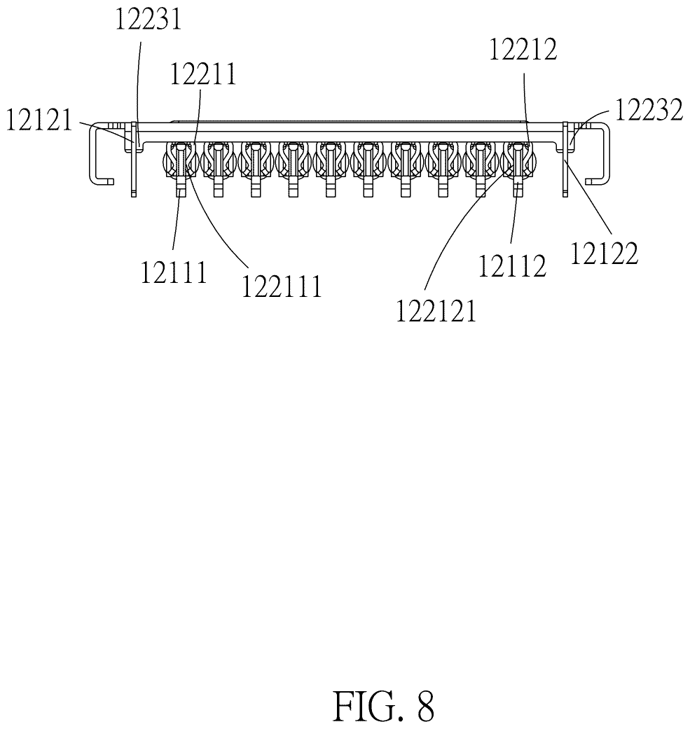

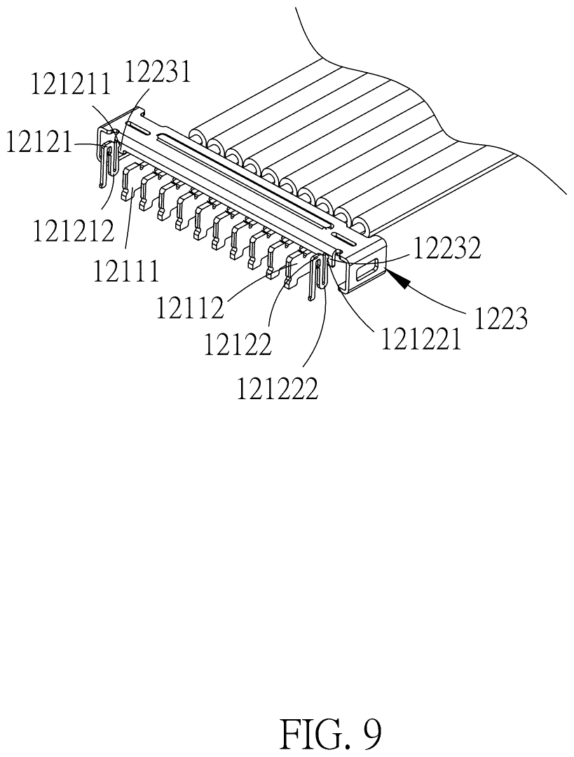

For a detailed description of the embodiments disclosed in the present application, please refer to FIGS. 1 to 12.

In the embodiment shown in FIGS. 1 to 12, a connector signal transmission system 1 and a connector signal transmission method thereof are disclosed. The connector signal transmission system 1 comprises a circuit board 11 and a connector assembly 12.

Regarding the circuit board 11, the circuit board 11 comprises a control module 110, a signal transmission module 111, a terminal contact detection module 112, and an effective engagement detection module 113. The signal transmission module 111 is configured to transmit a first terminal signal and a second terminal signal. It should be noted that the first terminal signal and the second terminal signal may be power signals or digital signals.

Regarding the connector assembly 12, the connector assembly 12 comprises a first connector engaging side L1 and a second connector engaging side L2. Optionally, the first connector engaging side L1 and the second connector engaging side L2 are opposite sides. Additionally, the connector assembly 12 comprises a board-end connector 121 and a cable-end connector 122. In the aforementioned embodiment, the board-end connector 121 is disposed on the circuit board 11 for signal transmission, and correspondingly, the cable-end connector 122 is engaged with the board-end connector 121 at the first connector engaging side L1 and the second connector engaging side L2. Thus, the circuit board 11 can transmit signals to the cable-end connector 122 via the board-end connector 121.

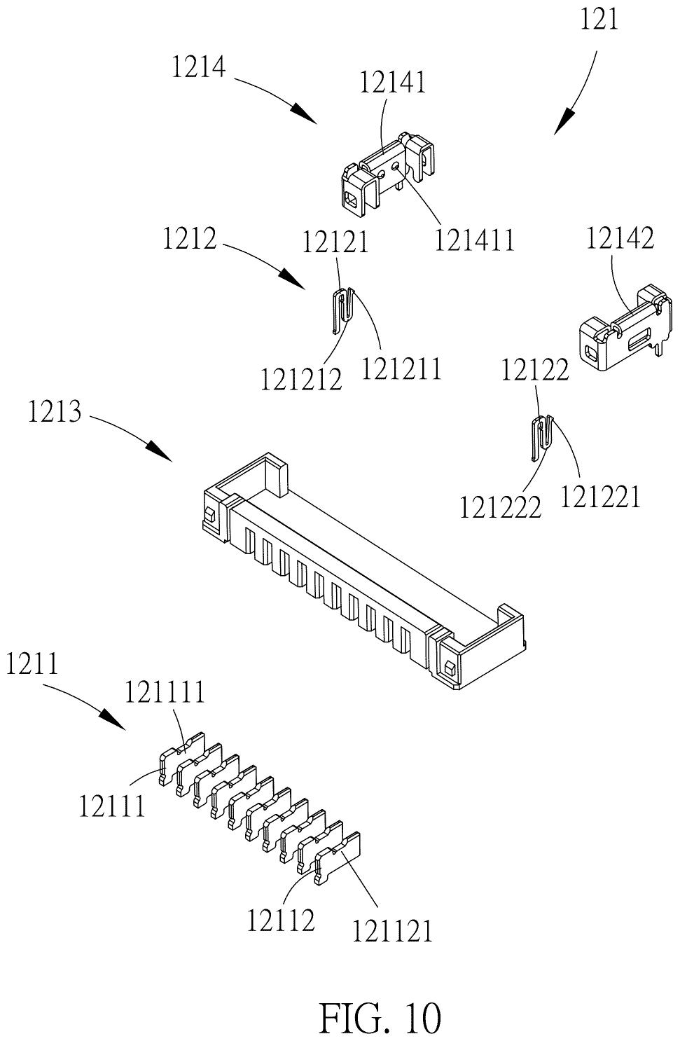

In the embodiment shown in FIG. 10, the board-end connector 121 comprises a board-end signal terminal set 1211, a board-end effective engagement detection component set 1212, and a board-end insulating core 1213.

With respect to the board-end signal terminal set 1211, when the board-end connector 121 is disposed on the circuit board 11, the board-end signal terminal set 1211 is electrically connected to the signal transmission module 111 and the terminal contact detection module 112, respectively, and comprises a first board-end signal terminal 12111 and a second board-end signal terminal 12112. The first board-end signal terminal 12111 and the second board-end signal terminal 12112 respectively comprise a first board-end signal terminal engaging structure 121111 and a second board-end signal terminal engaging structure 121121.

With respect to the board-end effective engagement detection component set 1212, when the board-end connector 121 is disposed on the circuit board 11, the board-end effective engagement detection component set 1212 is electrically connected to the effective engagement detection module 113 and comprises a first board-end effective engagement detection component 12121 and a second board-end effective engagement detection component 12122. The first board-end effective engagement detection component 12121 and the second board-end effective engagement detection component 12122 respectively comprise a first board-end effective engagement detection component engaging structure 121211 and a second board-end effective engagement detection component engaging structure 121221.

With respect to the board-end insulating core 1213, the board-end insulating core 1213 is configured to be mated with and to position the board-end signal terminal set 1211 and the board-end effective engagement detection component set 1212, such that the first board-end signal terminal engaging structure 121111 and the second board-end signal terminal engaging structure 121121 are respectively disposed at the first connector engaging side L1 and the second connector engaging side L2, and the first board-end effective engagement detection component engaging structure 121211 and the second board-end effective engagement detection component engaging structure 121221 are respectively disposed at the first connector engaging side L1 and the second connector engaging side L2.

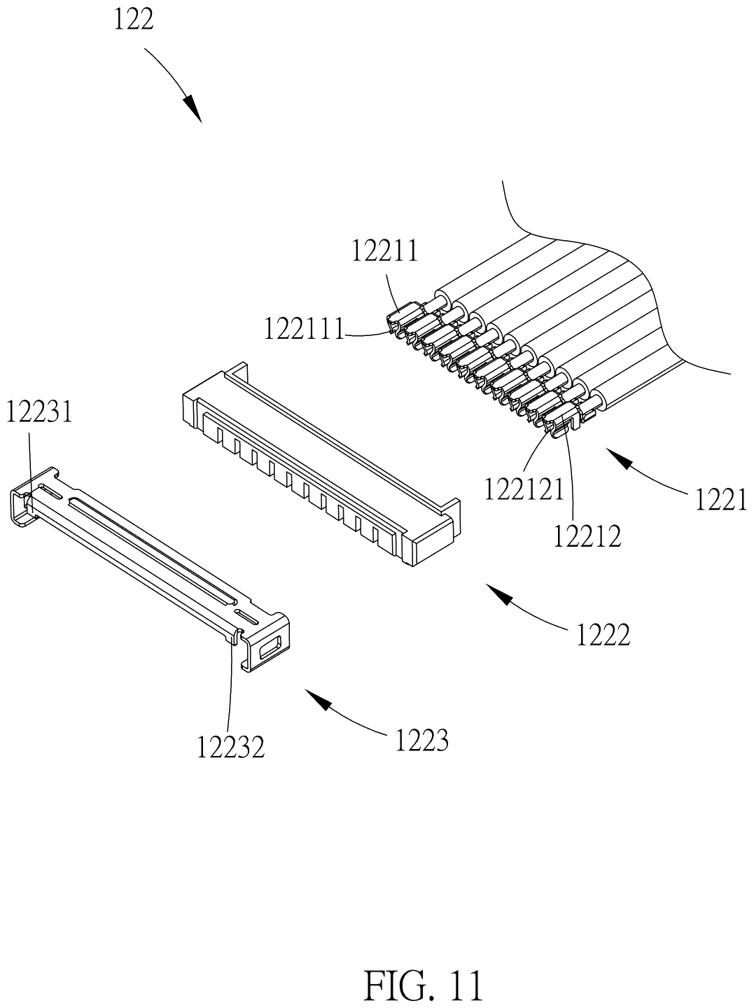

In the embodiment shown in FIG. 11, the cable-end connector 122 comprises a cable-end signal terminal set 1221, a cable-end insulating core 1222, and a cable-end effective engagement detection conductor 1223.

With respect to the cable-end signal terminal set 1221, the cable-end signal terminal set 1221 comprises a first cable-end signal terminal 12211 and a second cable-end signal terminal 12212. The first cable-end signal terminal 12211 and the second cable-end signal terminal 12212 respectively comprise a first cable-end signal terminal engaging structure 122111 and a second cable-end signal terminal engaging structure 122121.

With respect to the cable-end insulating core 1222, the cable-end insulating core 1222 is configured to be mated with and to position the cable-end signal terminal set 1221, such that the first cable-end signal terminal engaging structure 122111 and the second cable-end signal terminal engaging structure 122121 are respectively disposed at the first connector engaging side L1 and the second connector engaging side L2.

With respect to the cable-end effective engagement detection conductor 1223, the cable-end effective engagement detection conductor 1223 comprises a first cable-end effective engagement detection conductor structure 12231 and a second cable-end effective engagement detection conductor structure 12232. The cable-end effective engagement detection conductor 1223 is to be mated with and to position the cable-end insulating core 1222, such that the first cable-end effective engagement detection conductor structure 12231 and the second cable-end effective engagement detection conductor structure 12232 are respectively disposed at the first connector engaging side L1 and the second connector engaging side L2.

In the above embodiment, the cable-end effective engagement detection conductor 1223 is a metal shell to be mated with and to position the cable-end insulating core 1222 and being extended from the first connector engaging side L1 to the second connector engaging side L2. However, this is not limiting, and the cable-end effective engagement detection conductor 1223 may alternatively be a conductive material also to be mated with and to position the cable-end insulating core 1222 and being extended from the first connector engaging side L1 to the second connector engaging side L2.

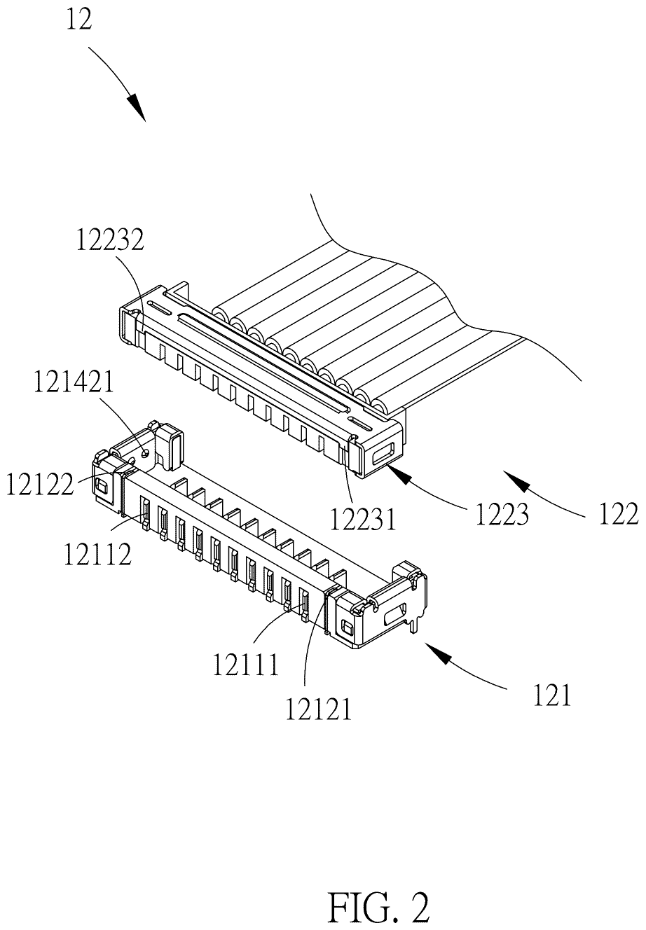

Optionally, in the embodiments shown in FIGS. 2 and 6 to 10, the first board-end signal terminal 12111 and the second board-end signal terminal 12112 are blade terminals; correspondingly, the first cable-end signal terminal 12211 and the second cable-end signal terminal 12212 are clip-arm terminals.

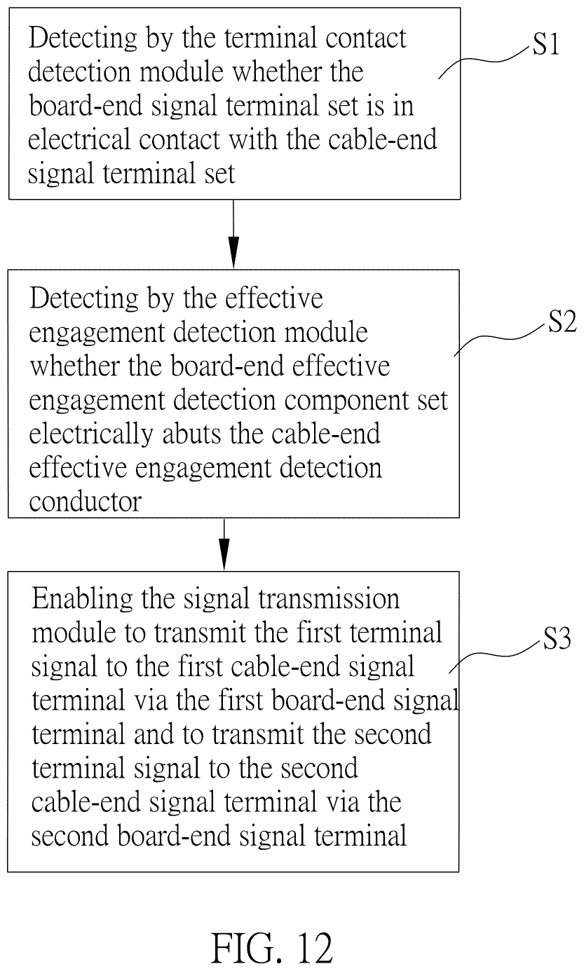

It should be noted that, regarding the connector signal transmission method, during engagement of the cable-end connector 122 with the board-end connector 121, in step S1 shown in FIG. 12, the control module 110 instructs the terminal contact detection module 112 to detect whether the board-end signal terminal set 1211 is in electrical contact with the cable-end signal terminal set 1221. In step S2 shown in FIG. 12, the control module 110 instructs the effective engagement detection module 113 to detect whether the board-end effective engagement detection component set 1212 is electrically abutted with the cable-end effective engagement detection conductor 1223.

In step S1, if the terminal contact detection module 112 detects that the first board-end signal terminal engaging structure 121111 is in electrical contact with the first cable-end signal terminal engaging structure 122111, and the second board-end signal terminal engaging structure 121121 is in electrical contact with the second cable-end signal terminal engaging structure 122121, and in step S2, the effective engagement detection module 113 detects that the first board-end effective engagement detection component 12121 and the second board-end effective engagement detection component 12122 are respectively electrically abutted with the cable-end effective engagement detection conductor 1223 (or with the first cable-end effective engagement detection conductor structure 12231 and the second cable-end effective engagement detection conductor structure 12232), this indicates that the cable-end connector 122 is effectively engaged with the board-end connector 121 at the first connector engaging side L1 and the second connector engaging side L2. Subsequently, in step S3 shown in FIG. 12, the control module 110 instructs the signal transmission module 111 to transmit the first terminal signal to the first cable-end signal terminal 12211 via the first board-end signal terminal 12111, and to transmit the second terminal signal to the second cable-end signal terminal 12212 via the second board-end signal terminal 12112. Accordingly, the control module 110 only instructs the signal transmission module 111 to transmit the first terminal signal and the second terminal signal after the cable-end connector 122 has been effectively engaged with the board-end connector 121 at the first connector engaging side L1 and the second connector engaging side L2, thereby allowing the connector assembly 12 to transmit signals stably and as expected in various electronic devices, and addressing the technical issue in conventional connector assemblies where connectors fail to transmit signals effectively due to incomplete engagement.

Optionally, in the embodiments shown in FIGS. 2 and 4 to 10, the first board-end effective engagement detection component 12121 and the second board-end effective engagement detection component 12122 respectively comprise a first board-end effective engagement detection component elastic abutting arm 121212 and a second board-end effective engagement detection component elastic abutting arm 121222. The first board-end effective engagement detection component elastic abutting arm 121212 and the second board-end effective engagement detection component elastic abutting arm 121222 are respectively configured to elastically abut the cable-end effective engagement detection conductor 1223 (or the first cable-end effective engagement detection conductor structure 12231 and the second cable-end effective engagement detection conductor structure 12232), such that the first board-end effective engagement detection component 12121 and the second board-end effective engagement detection component 12122 electrically abut the cable-end effective engagement detection conductor 1223 (or the first cable-end effective engagement detection conductor structure 12231 and the second cable-end effective engagement detection conductor structure 12232) as intended.

In the above embodiment, the board-end insulating core 1213 may further to be mated with and to position the board-end signal terminal set 1211, the first board-end effective engagement detection component 12121, and the second board-end effective engagement detection component 12122, such that the board-end signal terminal set 1211 is located between the first board-end effective engagement detection component 12121 and the second board-end effective engagement detection component 12122. This arrangement allows the board-end signal terminal set 1211 to electrically contact the cable-end signal terminal set 1221 earlier than the board-end effective engagement detection component set 1212 electrically abuts the cable-end effective engagement detection conductor 1223. Accordingly, when the cable-end connector 122 is effectively engaged with the board-end connector 121 at the first connector engaging side L1 and the second connector engaging side L2, the first board-end signal terminal engaging structure 121111 is in electrical contact with the first cable-end signal terminal 12211, and the second board-end signal terminal engaging structure 121121 is in electrical contact with the second cable-end signal terminal 12212. The control module 110 thus instructs the signal transmission module 111 to transmit the first terminal signal and the second terminal signal only after confirming electrical contact, enabling stable signal transmission and addressing the conventional issue of signal failure due to incomplete connector engagement.

In the embodiments shown in FIGS. 2, 5, and 10, the board-end connector 121 further comprises a board-end force-bearing member set 1214 comprising a first board-end force-bearing member 12141 and a second board-end force-bearing member 12142. The first board-end force-bearing member 12141 and the second board-end force-bearing member 12142 respectively comprise a first board-end force-bearing member locking structure 121411 and a second board-end force-bearing member locking structure 121421, such as a protruding structure. The board-end insulating core 1213 further to be mated with and to position the board-end force-bearing member set 1214, such that the first board-end force-bearing member locking structure 121411 and the second board-end force-bearing member locking structure 121421 are respectively disposed at the first connector engaging side L1 and the second connector engaging side L2. When the cable-end connector 122 is effectively engaged with the board-end connector 121, the first board-end force-bearing member locking structure 121411 and the second board-end force-bearing member locking structure 121421 lock and position the cable-end connector 122 to maintain the engagement state and prevent disengagement.

It should be noted that, in the embodiment shown in FIG. 1, the first board-end force-bearing member 12141 and the second board-end force-bearing member 12142 may respectively abut the circuit board 11 to position the board-end connector 121 on the circuit board 11.

Optionally, when the cable-end connector 122 is effectively engaged with the board-end connector 121 at the first connector engaging side L1 and the second connector engaging side L2, the first board-end force-bearing member locking structure 121411 and the second board-end force-bearing member locking structure 121421 may be configured to respectively lock and position the cable-end effective engagement detection conductor 1223 or the cable-end insulating core 1222, thereby achieving locking engagement via either component.

It should be noted that the connector assembly and board-end connector of the present application may omit some components and are not limited to the embodiments described above.

For example, the board-end connector of the present application may optionally comprise: a board-end signal terminal set, a board-end effective engagement detection component set, and a board-end insulating core. The board-end signal terminal set is electrically connected to the signal transmission module and comprises a first board-end signal terminal and a second board-end signal terminal. The first board-end signal terminal and the second board-end signal terminal respectively comprise a first board-end signal terminal engaging structure and a second board-end signal terminal engaging structure. The board-end effective engagement detection component set comprises a first board-end effective engagement detection component and a second board-end effective engagement detection component. The first board-end effective engagement detection component and the second board-end effective engagement detection component respectively comprise a first board-end effective engagement detection component engaging structure and a second board-end effective engagement detection component engaging structure. The board-end insulating core is engaged to position the board-end signal terminal set and the board-end effective engagement detection component set, such that the first board-end signal terminal engaging structure and the second board-end signal terminal engaging structure are respectively located at the first connector engaging side L1 and the second connector engaging side L2, and the first board-end effective engagement detection component engaging structure and the second board-end effective engagement detection component engaging structure are also respectively located at the first connector engaging side L1 and the second connector engaging side L2. Wherein, during the mating process of the cable-end connector with the board-end connector, if the first board-end signal terminal engaging structure and the second board-end signal terminal engaging structure are electrically in contact with the first cable-end signal terminal and the second cable-end signal terminal respectively, and if the first board-end effective engagement detection component and the second board-end effective engagement detection component are electrically abutted by the cable-end effective engagement detection conductor, it indicates that the cable-end connector has engaged and positioned the board-end connector at the first connector engaging side L1 and the second connector engaging side L2. Subsequently, the signal transmission module transmits a first terminal signal from the first board-end signal terminal to the first cable-end signal terminal, and also transmits a second terminal signal from the second board-end signal terminal to the second cable-end signal terminal.

Additionally, the connector assembly of the present application may optionally comprise only a board-end connector and a cable-end connector. The board-end connector comprises: a board-end signal terminal set, a board-end effective engagement detection component set, and a board-end insulating core. The board-end signal terminal set is electrically connected to the signal transmission module and comprises a first board-end signal terminal and a second board-end signal terminal. The first board-end signal terminal and the second board-end signal terminal respectively comprise a first board-end signal terminal engaging structure and a second board-end signal terminal engaging structure. The board-end effective engagement detection component set comprises a first board-end effective engagement detection component and a second board-end effective engagement detection component. The first board-end effective engagement detection component and the second board-end effective engagement detection component respectively comprise a first board-end effective engagement detection component engaging structure and a second board-end effective engagement detection component engaging structure. The board-end insulating core is engaged to position the board-end signal terminal set and the board-end effective engagement detection component set, such that the first board-end signal terminal engaging structure and the second board-end signal terminal engaging structure are respectively located at the first connector engaging side L1 and the second connector engaging side L2, and the first board-end effective engagement detection component engaging structure and the second board-end effective engagement detection component engaging structure are also respectively located at the first connector engaging side L1 and the second connector engaging side L2. The cable-end connector can mate with the board-end connector at the first connector engaging side L1 and the second connector engaging side L2, and comprises: a cable-end signal terminal set, a cable-end insulating core, and a cable-end effective engagement detection conductor. The cable-end signal terminal set comprises a first cable-end signal terminal and a second cable-end signal terminal. The first cable-end signal terminal and the second cable-end signal terminal respectively comprise a first cable-end signal terminal engaging structure and a second cable-end signal terminal engaging structure. The cable-end insulating core is engaged to position the cable-end signal terminal set, such that the first cable-end signal terminal engaging structure and the second cable-end signal terminal engaging structure are respectively located at the first connector engaging side L1 and the second connector engaging side L2. The cable-end effective engagement detection conductor comprises a first cable-end effective engagement detection conductor structure and a second cable-end effective engagement detection conductor structure, and is joined to the cable-end insulating core such that the first cable-end effective engagement detection conductor structure and the second cable-end effective engagement detection conductor structure are respectively located at the first connector engaging side L1 and the second connector engaging side L2. Wherein, during the mating process of the cable-end connector with the board-end connector, if the first board-end signal terminal engaging structure and the second board-end signal terminal engaging structure are electrically in contact with the first cable-end signal terminal engaging structure and the second cable-end signal terminal engaging structure respectively, and if the first board-end effective engagement detection component and the second board-end effective engagement detection component are electrically abutted by the first cable-end effective engagement detection conductor structure and the second cable-end effective engagement detection conductor structure respectively, it indicates that the cable-end connector has engaged and positioned the board-end connector at the first connector engaging side L1 and the second connector engaging side L2. Subsequently, the signal transmission module transmits a first terminal signal from the first board-end signal terminal to the first cable-end signal terminal and a second terminal signal from the second board-end signal terminal to the second cable-end signal terminal.

Furthermore, the connector signal transmission system of the present application may optionally comprise only: a circuit board and a connector assembly. The circuit board comprises a control module, a signal transmission module, a terminal contact detection module, and an effective engagement detection module, wherein the signal transmission module is configured to transmit a first terminal signal and a second terminal signal. The connector assembly comprises a first connector engaging side and a second connector engaging side, and comprises a board-end connector and a cable-end connector. The board-end connector is disposed on the circuit board, and the cable-end connector is capable of mating with the board-end connector at the first connector engaging side L1 and the second connector engaging side L2. The board-end connector comprises: a board-end signal terminal set and a board-end effective engagement detection component set. The board-end signal terminal set is electrically connected to the terminal contact detection module and the signal transmission module, and comprises a first board-end signal terminal and a second board-end signal terminal. The first board-end signal terminal and the second board-end signal terminal respectively comprise a first board-end signal terminal engaging structure and a second board-end signal terminal engaging structure, which are respectively located at the first connector engaging side L1 and the second connector engaging side L2. The board-end effective engagement detection component set is electrically connected to the effective engagement detection module and comprises a first board-end effective engagement detection component and a second board-end effective engagement detection component. The first board-end effective engagement detection component and the second board-end effective engagement detection component respectively comprise a first board-end effective engagement detection component engaging structure and a second board-end effective engagement detection component engaging structure, which are respectively located at the first connector engaging side L1 and the second connector engaging side L2. The cable-end connector comprises: a cable-end signal terminal set and a cable-end effective engagement detection conductor. The cable-end signal terminal set comprises a first cable-end signal terminal and a second cable-end signal terminal. The first cable-end signal terminal and the second cable-end signal terminal respectively comprise a first cable-end signal terminal engaging structure and a second cable-end signal terminal engaging structure, which are respectively located at the first connector engaging side L1 and the second connector engaging side L2. The cable-end effective engagement detection conductor extends from the first connector engaging side to the second connector engaging side. Wherein, during the mating process of the cable-end connector with the board-end connector, the control module instructs the terminal contact detection module to detect whether the board-end signal terminal set is electrically in contact with the cable-end signal terminal set, and instructs the effective engagement detection module to detect whether the board-end effective engagement detection component set is electrically abutted by the cable-end effective engagement detection conductor. If the result detected by the terminal contact detection module indicates that the first board-end signal terminal engaging structure and the second board-end signal terminal engaging structure are respectively electrically in contact with the first cable-end signal terminal engaging structure and the second cable-end signal terminal engaging structure, and the result detected by the effective engagement detection module indicates that the first board-end effective engagement detection component and the second board-end effective engagement detection component are electrically abutted by the cable-end effective engagement detection conductor, it indicates that the cable-end connector has engaged and positioned the board-end connector at the first connector engaging side L1 and the second connector engaging side L2. Subsequently, the control module instructs the signal transmission module to transmit a first terminal signal from the first board-end signal terminal to the first cable-end signal terminal, and also to transmit a second terminal signal from the second board-end signal terminal to the second cable-end signal terminal.

Additionally, the connector signal transmission method of the present application may optionally comprise the following steps: instructing the terminal contact detection module to detect whether the board-end signal terminal set is electrically in contact with the cable-end signal terminal set; instructing the effective engagement detection module to detect whether the board-end effective engagement detection component set is electrically abutted by the cable-end effective engagement detection conductor; and based on the detection result from the terminal contact detection module, if it is found that the first board-end signal terminal engaging structure and the second board-end signal terminal engaging structure are respectively electrically in contact with the first cable-end signal terminal and the second cable-end signal terminal, and based on the detection result from the effective engagement detection module, if it is found that the first board-end effective engagement detection component and the second board-end effective engagement detection component are electrically abutted by the cable-end effective engagement detection conductor, then instructing the signal transmission module to transmit a first terminal signal from the first board-end signal terminal to the first cable-end signal terminal, and to transmit a second terminal signal from the second board-end signal terminal to the second cable-end signal terminal.

In summary, the present application provides a connector signal transmission system and its transmission method, as well as a connector assembly and a board-end connector. The connector assembly further comprises a cable-end connector capable of mating with the board-end connector. The connector signal transmission system comprises a signal transmission module, a terminal contact detection module, and an effective engagement detection module. The terminal contact detection module is configured to detect whether the conductive terminals of the board-end and cable-end connectors are in contact, and the effective engagement detection module is configured to detect whether the conductive terminals of the board-end and cable-end connectors are engaged and positioned. If the detection results are affirmative, it indicates that the cable-end connector has been effectively mated with the board-end connector. Thereafter, the signal transmission module transmits signals through the connector assembly. This arrangement addresses the technical issue in conventional connector assemblies where multiple connectors may fail to transmit signals effectively due to improper mating, thereby ensuring timely signal transmission as intended in electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A board-end connector configured to be paired with a signal transmission module, wherein the signal transmission module is configured to provide a first terminal signal and a second terminal signal, and the board-end connector is further configured to be paired with a cable-end connector to form a connector assembly, the connector assembly comprising a first connector engaging side and a second connector engaging side, wherein the cable-end connector is engaged with the board-end connector at the first connector engaging side and the second connector engaging side, and comprises a cable-end signal terminal set and a cable-end effective engagement detection conductor, wherein the cable-end effective engagement detection conductor is extended from the first connector engaging side to the second connector engaging side, and the cable-end signal terminal set comprises a first cable-end signal terminal disposed at the first connector engaging side and a second cable-end signal terminal disposed at the second connector engaging side; the board-end connector comprising:
a board-end signal terminal set electrically connected to the signal transmission module and comprising a first board-end signal terminal and a second board-end signal terminal, wherein the first board-end signal terminal comprises a first board-end signal terminal engaging structure, and the second board-end signal terminal comprises a second board-end signal terminal engaging structure;
a board-end effective engagement detection component set comprising a first board-end effective engagement detection component and a second board-end effective engagement detection component, wherein the first board-end effective engagement detection component comprises a first board-end effective engagement detection component engaging structure, and the second board-end effective engagement detection component comprises a second board-end effective engagement detection component engaging structure; and
a board-end insulating core configured to be mated with and to position the board-end signal terminal set and the board-end effective engagement detection component set, such that the first board-end signal terminal engaging structure is disposed at the first connector engaging side, the second board-end signal terminal engaging structure is disposed at the second connector engaging side, the first board-end effective engagement detection component engaging structure is disposed at the first connector engaging side, and the second board-end effective engagement detection component engaging structure is disposed at the second connector engaging side; wherein,
during engagement between the cable-end connector and the board-end connector, when the first board-end signal terminal engaging structure and the second board-end signal terminal engaging structure are electrically in contact with the first cable-end signal terminal and the second cable-end signal terminal respectively, and when the first board-end effective engagement detection component and the second board-end effective engagement detection component electrically abut the cable-end effective engagement detection conductor, the cable-end connector is effectively engaged with the board-end connector at the first connector engaging side and the second connector engaging side, such that the signal transmission module is enabled to transmit the first terminal signal to the first cable-end signal terminal via the first board-end signal terminal and to transmit the second terminal signal to the second cable-end signal terminal via the second board-end signal terminal.

2. The board-end connector of claim 1, wherein the board-end signal terminal set is disposed between the first board-end effective engagement detection component and the second board-end effective engagement detection component.

3. The board-end connector of claim 1, wherein the first board-end effective engagement detection component comprises a first board-end effective engagement detection component elastic abutting arm, and the second board-end effective engagement detection component comprises a second board-end effective engagement detection component elastic abutting arm, wherein the first board-end effective engagement detection component elastic abutting arm and the second board-end effective engagement detection component elastic abutting arm are configured to elastically abut the cable-end effective engagement detection conductor.

4. A connector assembly comprising a first connector engaging side and a second connector engaging side, and configured to be paired with a signal transmission module, wherein the signal transmission module is configured to provide a first terminal signal and a second terminal signal; the connector assembly comprising:
a board-end connector, comprising:
a board-end signal terminal set electrically connected to the signal transmission module and comprising a first board-end signal terminal and a second board-end signal terminal, wherein the first board-end signal terminal comprises a first board-end signal terminal engaging structure, and the second board-end signal terminal comprises a second board-end signal terminal engaging structure;
a board-end effective engagement detection component set comprising a first board-end effective engagement detection component and a second board-end effective engagement detection component, wherein the first board-end effective engagement detection component comprises a first board-end effective engagement detection component engaging structure, and the second board-end effective engagement detection component comprises a second board-end effective engagement detection component engaging structure; and
a board-end insulating core configured to be mated with and to position the board-end signal terminal set and the board-end effective engagement detection component set, such that the first board-end signal terminal engaging structure is disposed at the first connector engaging side, the second board-end signal terminal engaging structure is disposed at the second connector engaging side, the first board-end effective engagement detection component engaging structure is disposed at the first connector engaging side, and the second board-end effective engagement detection component engaging structure is disposed at the second connector engaging side; and
a cable-end connector engaged with the board-end connector at the first connector engaging side and the second connector engaging side, the cable-end connector comprising:
a cable-end signal terminal set comprising a first cable-end signal terminal and a second cable-end signal terminal, wherein the first cable-end signal terminal comprises a first cable-end signal terminal engaging structure, and the second cable-end signal terminal comprises a second cable-end signal terminal engaging structure;
a cable-end insulating core configured to be mated with and to position the cable-end signal terminal set, such that the first cable-end signal terminal engaging structure is disposed at the first connector engaging side, and the second cable-end signal terminal engaging structure is disposed at the second connector engaging side; and
a cable-end effective engagement detection conductor comprising a first cable-end effective engagement detection conductor structure and a second cable-end effective engagement detection conductor structure, wherein the cable-end effective engagement detection conductor is mated with the cable-end insulating core such that the first cable-end effective engagement detection conductor structure is disposed at the first connector engaging side, and the second cable-end effective engagement detection conductor structure is disposed at the second connector engaging side; wherein,
during engagement of the cable-end connector with the board-end connector, when the first board-end signal terminal engaging structure and the second board-end signal terminal engaging structure are electrically in contact with the first cable-end signal terminal engaging structure and the second cable-end signal terminal engaging structure respectively, and when the first board-end effective engagement detection component and the second board-end effective engagement detection component electrically abut the first cable-end effective engagement detection conductor structure and the second cable-end effective engagement detection conductor structure respectively, the cable-end connector is effectively engaged with the board-end connector at the first connector engaging side and the second connector engaging side, such that the signal transmission module is enabled to transmit the first terminal signal to the first cable-end signal terminal via the first board-end signal terminal and to transmit the second terminal signal to the second cable-end signal terminal via the second board-end signal terminal.

5. The connector assembly of claim 4, wherein the cable-end effective engagement detection conductor is a metal shell or conductive material to be mated with the cable-end insulating core.

6. The connector assembly of claim 4, wherein the first board-end signal terminal and the second board-end signal terminal are blade terminals, and the first cable-end signal terminal and the second cable-end signal terminal are clip-arm terminals.

7. The connector assembly of claim 4, wherein the board-end connector further comprises a board-end force-bearing member set, and the board-end force-bearing member set comprises a first board-end force-bearing member and a second board-end force-bearing member, wherein the first board-end force-bearing member and the second board-end force-bearing member respectively comprise a first board-end force-bearing member locking structure and a second board-end force-bearing member locking structure, and the board-end insulating core is further configured to be mated with and to position the board-end force-bearing member set, such that the first board-end force-bearing member locking structure and the second board-end force-bearing member locking structure are respectively disposed at the first connector engaging side and the second connector engaging side; wherein, when the cable-end connector is effectively engaged with the board-end connector at the first connector engaging side and the second connector engaging side, the first board-end force-bearing member locking structure and the second board-end force-bearing member locking structure are configured to lock and position the cable-end connector.

8. The connector assembly of claim 7, wherein when the cable-end connector is effectively engaged with the board-end connector at the first connector engaging side and the second connector engaging side, the first board-end force-bearing member locking structure and the second board-end force-bearing member locking structure are configured to lock and position the cable-end effective engagement detection conductor or the cable-end insulating core.

9. A connector signal transmission system comprising:
a circuit board comprising a control module, a signal transmission module, a terminal contact detection module, and an effective engagement detection module, wherein the signal transmission module is configured to transmit a first terminal signal and a second terminal signal; and
a connector assembly comprising a first connector engaging side and a second connector engaging side, the connector assembly comprising a board-end connector and a cable-end connector, wherein the board-end connector is disposed on the circuit board, and the cable-end connector is engaged with the board-end connector at the first connector engaging side and the second connector engaging side, wherein,
the board-end connector comprises:
a board-end signal terminal set electrically connected to the terminal contact detection module and the signal transmission module, and comprising a first board-end signal terminal and a second board-end signal terminal, wherein the first board-end signal terminal comprises a first board-end signal terminal engaging structure disposed at the first connector engaging side, and the second board-end signal terminal comprises a second board-end signal terminal engaging structure disposed at the second connector engaging side; and
a board-end effective engagement detection component set electrically connected to the effective engagement detection module, and comprising a first board-end effective engagement detection component and a second board-end effective engagement detection component, wherein the first board-end effective engagement detection component and the second board-end effective engagement detection component respectively comprise a first board-end effective engagement detection component engaging structure and a second board-end effective engagement detection component engaging structure, and the first board-end effective engagement detection component engaging structure and the second board-end effective engagement detection component engaging structure are respectively disposed at the first connector engaging side and the second connector engaging side; and
the cable-end connector comprises:
a cable-end signal terminal set comprising a first cable-end signal terminal and a second cable-end signal terminal, wherein the first cable-end signal terminal and the second cable-end signal terminal respectively comprise a first cable-end signal terminal engaging structure and a second cable-end signal terminal engaging structure, and the first cable-end signal terminal engaging structure and the second cable-end signal terminal engaging structure are respectively disposed at the first connector engaging side and the second connector engaging side; and
a cable-end effective engagement detection conductor extended from the first connector engaging side to the second connector engaging side;
wherein,
during engagement of the cable-end connector with the board-end connector, the control module is configured to instruct the terminal contact detection module to detect whether the board-end signal terminal set is in electrical contact with the cable-end signal terminal set, and the control module is further configured to instruct the effective engagement detection module to detect whether the board-end effective engagement detection component set electrically abut the cable-end effective engagement detection conductor; when the terminal contact detection module detects that the first board-end signal terminal engaging structure and the second board-end signal terminal engaging structure are in electrical contact with the first cable-end signal terminal engaging structure and the second cable-end signal terminal engaging structure respectively, and when the effective engagement detection module detects that the first board-end effective engagement detection component and the second board-end effective engagement detection component electrically abut the cable-end effective engagement detection conductor, the cable-end connector is effectively engaged with the board-end connector at the first connector engaging side and the second connector engaging side, such that the control module instructs the signal transmission module to transmit the first terminal signal to the first cable-end signal terminal via the first board-end signal terminal and to transmit the second terminal signal to the second cable-end signal terminal via the second board-end signal terminal.

10. A connector signal transmission method for use in a connector signal transmission system, wherein,
the connector signal transmission system comprises a circuit board and a connector assembly, the connector assembly comprising a first connector engaging side and a second connector engaging side; the circuit board comprises a signal transmission module, a terminal contact detection module, and an effective engagement detection module, wherein the signal transmission module is configured to transmit a first terminal signal and a second terminal signal; the connector assembly comprises a board-end connector and a cable-end connector; the board-end connector comprises a board-end signal terminal set and a board-end effective engagement detection component set, and is disposed on the circuit board, such that the board-end signal terminal set is electrically connected to the terminal contact detection module and the signal transmission module, and the board-end effective engagement detection component set is electrically connected to the effective engagement detection module, wherein the board-end signal terminal set comprises a first board-end signal terminal and a second board-end signal terminal, and the board-end effective engagement detection component set comprises a first board-end effective engagement detection component and a second board-end effective engagement detection component; the cable-end connector is engaged with the board-end connector, and comprises a cable-end signal terminal set and a cable-end effective engagement detection conductor, wherein the cable-end signal terminal set comprises a first cable-end signal terminal and a second cable-end signal terminal, and the cable-end effective engagement detection conductor is extended from the first connector engaging side to the second connector engaging side; the connector signal transmission method comprises:
detecting by the terminal contact detection module whether the board-end signal terminal set is in electrical contact with the cable-end signal terminal set;
detecting by the effective engagement detection module whether the board-end effective engagement detection component set electrically abuts the cable-end effective engagement detection conductor; and
when the terminal contact detection module detects that the first board-end signal terminal and the second board-end signal terminal are respectively in electrical contact with the first cable-end signal terminal and the second cable-end signal terminal, and when the effective engagement detection module detects that the first board-end effective engagement detection component and the second board-end effective engagement detection component electrically abut with the cable-end effective engagement detection conductor, enabling the signal transmission module to transmit the first terminal signal to the first cable-end signal terminal via the first board-end signal terminal and to transmit the second terminal signal to the second cable-end signal terminal via the second board-end signal terminal.

11. The connector signal transmission method of claim 10, wherein the time at which the board-end signal terminal set is in electrical contact with the cable-end signal terminal set is earlier than the time at which the board-end effective engagement detection component set electrically abuts the cable-end effective engagement detection conductor, such that when the cable-end connector is effectively engaged with the board-end connector at the first connector engaging side and the second connector engaging side, the first board-end signal terminal is electrically in contact with the first cable-end signal terminal, and the second board-end signal terminal is electrically in contact with the second cable-end signal terminal.
